(19) United States
(12) Patent Application Publication
(10) Pub. No.: US 2005/0222700 A1
(43) Pub. Date: Oct. 6, 2005

(54) Components-structure management system for repair components

(75) Inventor: Mutsuo Itano, Tokyo (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 11/092,649

(22) Filed: Mar. 29, 2005

(30) Foreign Application Priority Data
Mar. 31, 2004 (JP) 2004-107197

(51) Int. Cl. G06F 19/00

(52) U.S. Cl. 700/106; 700/97

(57) ABSTRACT

Components constituting a product are managed by using a server having a database storing a list of components associated with the product and a database storing a hierarchical relationship between the components. When a design of a component is changed or the mass production of the component is discontinued, the server collects information regarding the component and retrieves a product using the component. Then, the server generates and outputs component-structure information of a section of changed components in the components of the product.

### BACKGROUND OF THE INVENTION

1. Field of the Invention

The present invention relates to a components-structure management system for managing a components structure of repair components.

2. Description of the Related Art

Machinery products exemplified by motor vehicles, motorcycles, and general-purpose machines (engine-using products, such as electric generators, cultivators, outboard machines, and lawnmowers) are constituted of an extremely large number of intricately assembled components. Manufacturers for such machinery products manage information of components used for each of a large variety of the machinery products. In addition, for such products, even after the mass production thereof is discontinued, an organization must be maintained to be capable of supplying an extremely large variety of repair components.

In this connection, known techniques include an equipment application calculation system as disclosed in Japanese Unexamined Patent Application Publication No. 2003-296376 (Patent Document 1). The calculation system has a product variation calculation section, a component application section, and a component table calculation section. The product variation calculation section calculates a product variation table that correlates a plurality of product variations, which are variations of a plurality of products, with a plurality of equipments related to the products and specifications. The component application section calculates a component characteristic table that, in accordance with a plurality of specification-difference equipments and components that determine differences in specifications of components among a plurality of equipments, provides correlations between specification-difference equipment variations, which are variations in combinations of the individual specification difference equipments, the specification difference equipments, and the components. In accordance with the specification-difference equipment variations and the product variations, the component table calculation section calculates a component table that provides correlations between the product variations, which are the product variations including the specification difference equipment variations.

Additionally known is a component quality control method as disclosed in Japanese Unexamined Patent Publication No. 2003-228408 (Patent Document 2). According to this method, after being registered by being divided into a plurality of units that constitute individual models of individual specification products and that are usable with at least one of the individual models, and at least one component constituting the unit is registered into a lower level of the units. When an order for a product is received, a component model table of the product is created in the manner that units are selected and combined in response to the contents of the order.

As shown in FIG. 1, as a method of performing management of a large number component having hierarchical inclusive relationships, a method of performing the management by using a database of a relational tree structure 200 is contemplated. A product 202 is constituted of a plurality of L1 components 204 (level-1 components). The respective L1 component 204 is constituted of an L2 component 206 (level-2 component). The respective L2 component is constituted of L3 components (level-3 component). For a product A, components thereof are described using a corresponding relational tree structure 200. For an other product B, components thereof is described using a corresponding relational tree structure 200 different in element from that of the product A.

In the event that a design change is applied to components represented by using such the relational tree structure 200 or the production of the component is discontinued, the management different corresponding to individual cases described below must be carried out.

(1) Case Where Component Design Drawings are Changed

A case can occur where a component undergoes a design change by a designer to a different shape or a different material. A plurality of versions of the component that occur through the design change are managed in accordance with design-changed component numbers.

(2) Case Where a Design Change is Made Due to a Change in Combination

A case can occur where a component undergoes a design change due to a change in combination shown in a relational tree structure 200. For example, an L2 component used to constitute an L1 component 204 is substituted by a different L2 component. Alternatively, for example, a component used as an L2 component is managed as an L1 component. In such a case, a component of a minimum unit is not physically changed at all, but the combination thereof is changed.

(3) Case Where Design-Change Progress is Different Depending on the Product

A case can occur wherein components of a specific type are used for a plurality of products. In such a case, a case can occur wherein the design changes in (1) and (2) above for the components of the specific type are different corresponding to differences of products. For example, a case can occur wherein a version of a component X is used for a product A, and a different version b of the same component X is used for a product B.

(4) Case Where a Mass Production Component and a Repair Component are Eifferent from Each Other

A case can occur wherein a component used for the mass production of products in a factory is different in structure from a component being sold for repair.

When the cases (1) to (4) above mixedly occur, component management, particularly, design-change management becomes complex. According to the component-structure management using the relational tree structure 200, in response to a design-change occurrence, the entirety of the relational tree structure 200 is each time changed to completely reflect the components structure even including design-changed versions. For a product with a very large number of, for example, types of components or design-changed versions, the management is performed by using very large amounts of calculation time and memory.

Component management is performed in a plurality of organization units such as an organization unit being engaged in component design changes and an organization unit being engaged in the management of information on components structures. Complete management of component design changes by using the relational tree structure is accomplished by using inter-organization-unit traversing management numbers. The management numbers include management numbers necessary for management by one organization unit and management numbers necessary for management by another organization unit. The management is, therefore, very complex to deal with a case where management numbers unique in units of an organization unit are set.

In addition, suppose that the mass production has been discontinued for a product of a certain type of, for example, a motor vehicle, motorcycle, or general-purpose machine. In this case, in the components to be used for the product, components to be commonly used for other products being mass produced are easily available since the mass production thereof are continued even after the discontinuation of production. On the other hand, however, suppose that the mass production of a product of a certain type has been discontinued. In this case, the availability of components to be used only for the product is uneasy, and the price thereof can become different. As such, there arise demands for techniques for managing the procedure of supplying mass production-discontinued components such as repair components and the costs thereof.

Further, components of motor vehicles, motorcycles, and the like products are manufactured through variously different processing steps, such as those being manufactured in an own factory and those being serially manufactured by a large number of manufacturers. As such, it is difficult to perform management so as to enable repair components to be secured after the mass production has been discontinued.

### SUMMARY OF THE INVENTION

An object of the present invention is to provide a system that facilitates the management of a repair component being applied to a product.

Another object of the invention is to provide a system that facilitates management of a method of supplying a repair component after the mass production of a corresponding product has been discontinued.

Still another object of the invention is to provide a system that easily secures a method of obtaining a component even after the mass production of a component relevant to the component has been discontinued.

Still another object of the invention is to provide a system that causes information of a design change to be reflected in information of a repair component in the event that the design change has been made to the component being used as the repair component.

Still another object of the invention is to provide a system that enables supplying an appropriate repair component inclusive of a difference in variation in the event that the repair component is applied to each of products of types different in version from one another in the same series.

Yet another object of the invention is to provide a system that enables a management/supply task for repair components to be performed with reduced labor and time.

A components-structure management system according to the present invention has a component management server and a components-structure-information creation server connected to the component management server through a communication network.

The component management server includes a component management database configured to associate product IDs specifying kinds of products which are mass-produced and component IDs specifying kinds of components used for the products. The component management database stores the component IDs of components having a hierarchical relationship from a larger component to a smaller component together with the hierarchical relationship.

The component management server further includes: a mass production-discontinued product information database configured to store discontinued product IDs which are the product IDs specifying mass production-discontinued products; a mass production-discontinued component information database configured to store discontinued component IDs which are the component IDs specifying mass production-discontinued components; a component supply arrangement database configured to store the component IDs and supply arrangement information describing procedures of arranging the components specified by the components IDs in correlation with one another; and a unit price database configured to store the component IDs and unit price information indicating unit prices of the components after mass production of the components specified by the component IDs is discontinued in correlation with one another.

The components-structure-information creation server includes: a mass production-discontinued product information collection unit configured to collect the discontinued product IDs stored in the mass production-discontinued product information database from the component management server; a use-component extraction unit configured to extract as use-component IDs the component IDs of the components in all hierarchies associated with the discontinued product IDs in the component management database, when the mass production-discontinued product information collection unit collects the discontinued product IDs; and a discontinued use-component extraction unit configured to extract as discontinued use-component IDs the use-component IDs which are in accordance with the discontinued component IDs in the mass production-discontinued component information database, when the use-component extraction unit extracts the use-component IDs.

The components-structure-information creation server further includes: a supply arrangement information extraction unit configured to extract supply arrangement information associated with the discontinued use-component IDs in the component supply arrangement database as mass production-discontinued use-component supply means information, when the discontinued use-component extraction unit extracts the discontinued use-component IDs; a unit price information extraction unit configured to extract unit price information associated with the discontinued use-component IDs in the unit price database as mass production-discontinued use-component unit price information, when the discontinued use-component extraction unit extracts the discontinued use-component IDs; a component supply constitution management database configured to store the discontinued use-component IDs, the mass production-discontinued use-component supply means information, and the mass production-discontinued use-component unit price information in correlation with one another; and an input-output apparatus configured to search the component supply constitution management database.

Even when the mass production of a product or a component is discontinued, it is still necessary to keep selling components used for repairing the mass production-discontinued product and component. Particularly, in the cases of motor vehicles and motorcycles, it is required to supply the components used in the repair for a long time. When the mass production of a product is discontinued, some kinds of components used in the product can be obtained easily in a captive factory in some cases, because they can be applied to other products. In other cases, it is necessary to order the products or the components from outside factories. In still other cases, although the products or the components may be manufactured in the captive factory, it may be necessary to arrange materials of the products or the components for the manufacturing.

As mentioned above, there are various factors in securing the repair-purpose components after the products/components are discontinued, and to secure the repair-purpose components is difficult. According to the components-structure management system of the present invention, it is possible to easily comprehend the processes of obtaining the repair-purpose components which are discontinued after the mass production of the product or the component is discontinued. In particular, a large number of components are used in a motor vehicle and a motorcycle, and the repair-purpose components should be supplied for a long time. Thus, in the case of such a product, the system according to the present invention is of much use.

The component management server is used by an operations division which manages planning drawings of components, mutual compatibility of components, processes of arranging components and so on. A server for arranging the repair-purpose appropriately refers to the component management server and is used by an operations division which investigates components and processes necessary for manufacturing products.

In the components-structure management system according to the present invention, the component management server further includes a section database configured to store section IDs specifying sections which are parts constituting a product and the component IDs specifying components which are used in the sections specified by the section IDs and are located at a top-level hierarchy in the component management database. The use-component extraction unit extracts all the use-component IDs in accordance with classifications of the sections by using the component management database.

In a case of a transmission, for example, the section means a group of components such as a transmission casing, a clutch (low, second, third), a main shaft and so on. According to the components-structure management system of the present invention, it is possible to generate easily information regarding the constitution of the section with respect to a component, when information of the component is updated.

The components-structure management system according to the present invention further has a design change information creation server. The component management server further includes a design change database configured to store the component IDs and design change information indicating design changes performed for components specified by the component IDs in correlation with one another. The design change information creation server includes: a design change information collection unit configured to collect the component IDs and the design change information from the design change database; a design change product search/retrieval unit configured to search the component management database for a design change ID specifying a design change product which is a product to which design change components which are the components collected by the design change information collection unit are applied; and a variation components list generating unit configured to extract as design-changed-product-using components the components in all hierarchies of the hierarchical relationship associated with the design change product in the component management database, and to generate and output a variation components list which indicates difference between the extracted design-changed-product-using components and use components stored in the component supply constitution management database.

According to the components-structure management system of the present invention, it is possible to easily reflect a design change for a repair-purpose component when the design change is performed with regard to components used in the repair-purpose component. An operator of the components-structure management system can select rapidly the repair-purpose components with high customer satisfaction measurement (low cost, high quality, short delivery time and so on) by determining whether the components after the design change or the components before the design change should be applied to the repair-purpose component with reference to the variation components list.

According to the components-structure management system of the present invention, it is easy to calculate a total cost of the components used in a product when the information of the components is updated. Moreover, it is also easy to calculate a cost of the components used in a section or a component in a first hierarchy. In some cases, a cost of a component is different between during a product is under mass production and after the mass production due to a legal rule. According to the components-structure management system of the present invention, it is easy to calculate the cost or the price of the component/product in consideration of such a cost difference.

The extraction of the different points is preferably carried out on a periodic basis, for example, once a day. According to the components-structure management system, it is possible to comprehend the constitution of the component in almost real time, which is a benefit brought by the automation of the response to the design change.

In the components-structure management system according to the present invention, the component management server further includes a category database configured to store the product IDs and category information indicating product categories to which the products belong in correlation with one another. The design change database stores the component IDs and the product categories in which the design changes are performed for components specified by the component IDs in correlation with one another. The variation components list generating unit outputs the variation components list in accordance with classifications of the product categories.

The category indicates, for example, a distinction between a two-wheel vehicle, a four-wheel vehicle and a general-purpose machine, a distinction between a prototype and a mass production type, and a distinction between an engine and a frame. According to the components-structure management system, for example, in a case when a component is commonly used in a two-wheel vehicle and a four-wheel vehicle, and a different version component is used in the two-wheel vehicle and the four-wheel vehicle after a design change, it is possible to generate easily the constitution information of the component in accordance with the use.

In the case of a complicated machine product such as an automobile, a two-wheel vehicle, a general-purpose machine and the like, its components are obtained by ordering from various companies and various divisions. It is therefore preferable to manage the arrangement information indicative of the approved supplier and the processes of the arrangement with respect to each of the components. According to the components-structure management system of the present invention, it is possible to update the arrangement information to an appropriate one, when a design of a component is changed or mass production of a component/product is discontinued.

In the case of a vehicle, a large number of components are used for manufacturing, and used for a long time. Moreover, the design is often changed and the manufacturing of the components is often discontinued. In particular, a complicated process is required for managing components of an engine or a transmission. According to the components-structure management system of the present invention, it is possible to ease the complicated management of the constitution of the components.

According to the present invention, the system is provided that facilitates the management of a repair component being applied to a product.

In addition, according to the invention, the system is provided that facilitates the management of the method of supplying a repair component after the mass production of a corresponding product has been discontinued.

Further, according to the invention, the system is provided that easily secures the method of obtaining a component even after the mass production of a component relevant to the component has been discontinued.

Further, according to the invention, the system is provided that causes information of a design change to be reflected in information of a repair component automatically in the event that the design change has been made to the component being used as the repair component.

Further, according to the invention, the system is provided that enables supplying an appropriate repair component inclusive of a difference in variation in the event that the repair component is applied to each of products of types different in version from one another in the same series.

Furthermore, according to the invention, the system is provided that enables a management/supply task for repair components to be performed with reduced labor and time.

### BRIEF DESCRIPTION OF THE DRAWINGS

Additional objects and features of the present invention will be more readily apparent from the following detailed description and appended claims when taken in conjunction with the drawings, in which:

FIG. 1 shows a relational tree structure;

FIG. 2 shows the configuration of a components-structure management system;

FIG. 3 shows a configuration of databases stored in a storage unit of a component management server;

FIG. 4 shows a configuration of a L1 component number database;

FIG. 5 shows a configuration of a L2 component number database;

FIG. 6 shows a configuration of a section database;

FIG. 7 shows a configuration of a component database;

FIG. 8 shows a configuration of a component number database;

FIG. 9 shows a configuration of a component unit-price database;

FIG. 10 shows a configuration of a supply arrangement database;

FIG. 11 shows a configuration of a mass production information database;

FIG. 12 shows a configuration of a category database;

FIG. 13 shows a mass production-discontinued product information database;

FIG. 14 shows a configuration of a design change database;

FIG. 15 shows programs stored in a storage unit of a components-structure-information creation server;

FIG. 16 shows a configuration of a component provision constitution management database;

FIG. 17 shows programs stored in a design change information creation database;

FIG. 18 shows a flow diagram showing operation of the components-structure management system; and

FIG. 19 shows a flow diagram showing operation of the components-structure management system.

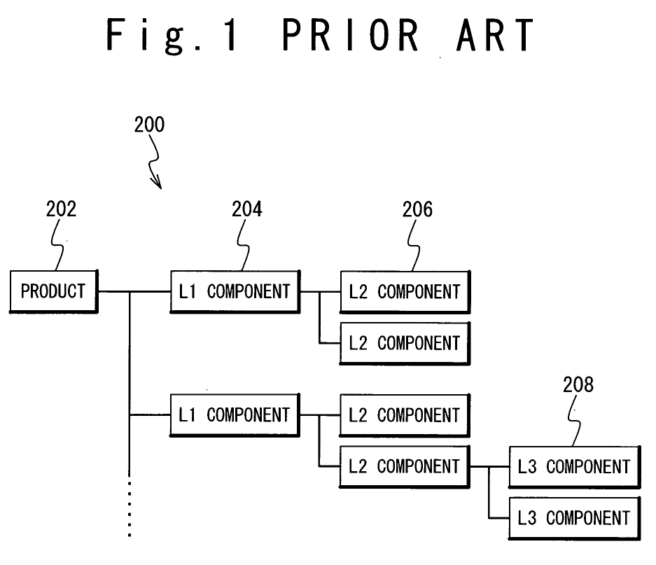

### DESCRIPTION OF THE PREFERRED EMBODIMENTS

Referring to the accompanying drawings, a components-structure management system of the present invention will be described in detail below.

The components-structure management system of the present invention is preferably usable for a product having a large number of types of components. More particularly, the system is suitably usable to manage repair components that are used for components frequently varied in components structure by, for example, product specification changes and design changes and that are required to be supplied for a long time even after discontinuation of mass production. Products for which such components are used are exemplified by engines and transmissions of motor vehicles, motorcycles, and general-purpose machines.

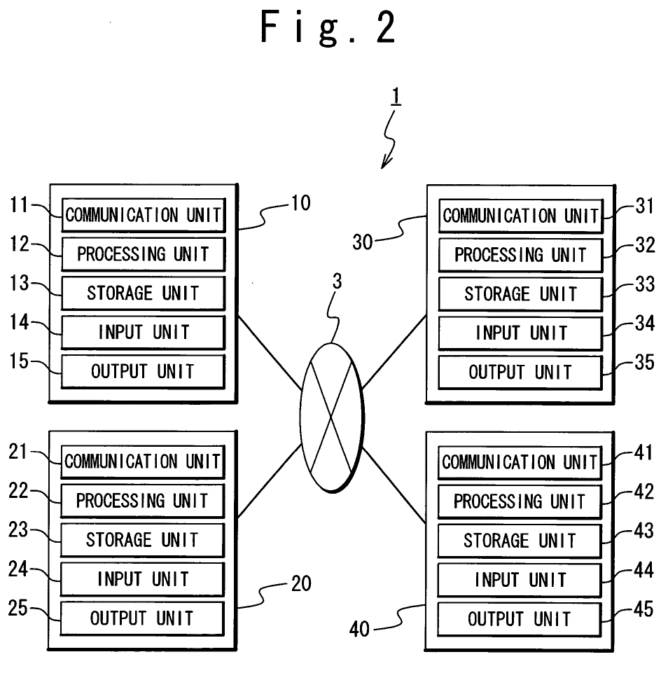

Referring to FIG. 2, the components-structure management system, of the present invention has a component update information management server 10, a component management server 20, a components-structure-information creation server 30, and a design change information creation server 40. The four servers can be constituted using a computer system exemplified by a personal computer or a workstation, wherein the individual servers are connected to be communicable with one another across a communication network 3.

The component update information management server 10 has a communication unit 11, a processing unit 12, a storage unit 13, an input section 14, and an output section 15. The component management server 20 has a communication unit 21, a processing unit 22, a storage unit 23, an input section 24, and an output section 25. The components-structure-information creation server 30 has a communication unit 31, a processing unit 32, a storage unit 33, an input section 34, and an output section 35. The design change information creation server 40 has a communication unit 41, a processing unit 42, a storage unit 43, an input section 44, and an output section 45.

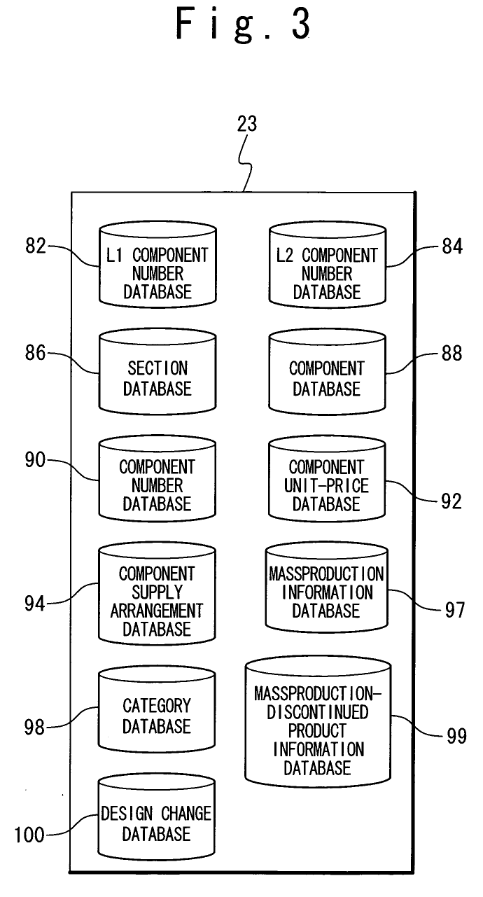

Referring to FIG. 3, the storage unit 23 of the component management server 20 stores various databases. They are an L1 component number database 82, an L2 component number database 84, a section database 86, a component database 88, a component number database 90, a component unit-price database 92, a component supply arrangement database 94, a mass production information database 97, a category database 98, a mass production-discontinued product information database 99, and a design change database 100.

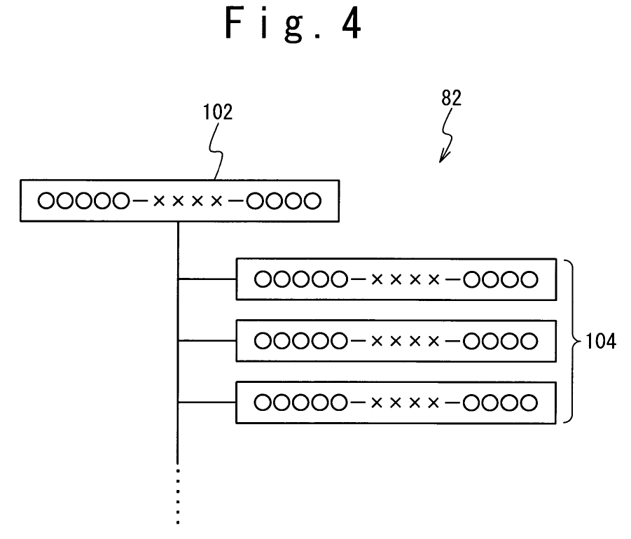

Referring to FIG. 4, the L1 component number database 82 stores product IDs (identifiers) 102 individually specifying models and variations of products such as motorcycles, four-wheel vehicles, and general-purpose machines (such as cultivators, lawnmowers, and electric generators), and L1 component numbers 104 individually specifying the L1 components constituting the products.

The L1 components will be described here. A manufacturer manages individual components constituting products by allocating managing numbers to the components that have hierarchical inclusive relationships among small components, average-sized components, and large components. The small component refers to, for example, a screw; the average-sized component refers to a component containing at least one small component; and the large component refers to a component containing at least one average-sized component. In the present Specification, a component belonging to the highest level of the hierarchical relationship is termed “L1 component” (level-1 component), and a managing number allocated thereto is termed “L1 component number.” For example, a single (vehicle) type of a motor vehicle is constituted of tens of thousands of types of components. Suppose that all L1 components of L1 component numbers 104 corresponding to a certain product ID in the L1 component number database 82 be collected from the L1 component number database 82. In this case, all components necessary to manufacture the corresponding product in a factory can be collected.

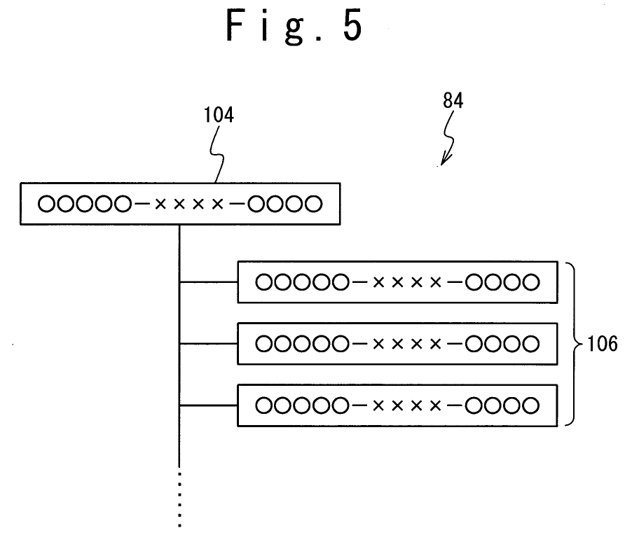

Referring to FIG. 5, the L2 component number database 84 stores L1 the component numbers 104 and L2 component numbers 106 in correlation with one another. The L2 component number 106 is a managing number allocated to an L2 component (level-2 component) constituting the L1 component.

Neither an L1 component number 104 nor L2 component number 106 themselves does not need to contain information that identifies whether the number is the L1 component number or the L2 component number. Whether a certain component number is an L1 component number or an L2 component number is identified by a comparison with any one of the L1 component number database 82 and the L2 component number database 84.

At hierarchical levels further below the L2 components, other components such as L3 components (level-3 components) and L4 components (level-4 components) may be established. In the present embodiment, however, the L2 components are assumed to be the lowest level components for the sake of simplicity.

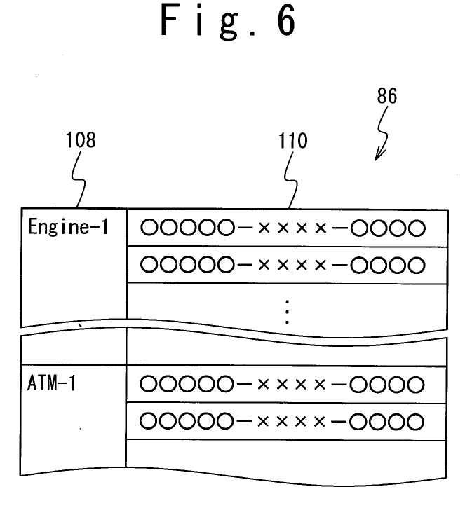

Referring to FIG. 6, the section database 86 stores sections 108 and component numbers 110 in correlation with one another. The component number 110 may include any of the L1 component number 104 and the L2 component number 106.

The aforementioned “section” will be described here. A manufacturer lists components constituting products by using respective maps rendered in units a portion of a respective product. One of the respective maps corresponds to the “section.” For example, for an engine, the respective section corresponds to a cylinder head, oil pump, exhaust manifold, or the like.

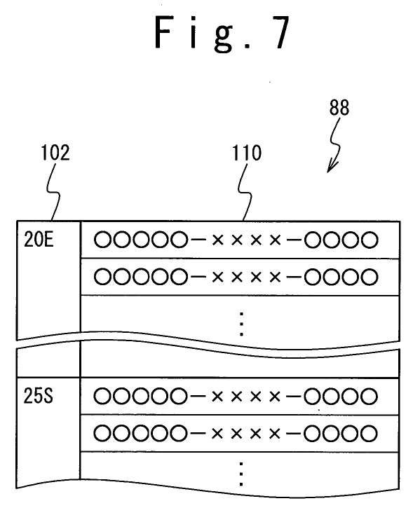

Referring to FIG. 7, the component database 88 stores the product IDs 102 and the component numbers 110 in correlation with one another. With the component database 88, components constituting a certain product are flatly managed without the hierarchical classification between the L1 component number and the L2 component number. The product ID 102 includes category information representing product categories. The category information represents, for example, categories of motorcycles, four-wheel vehicles, and general-purpose machines; categories of prototype types and mass production types; and categories of engines and frames.

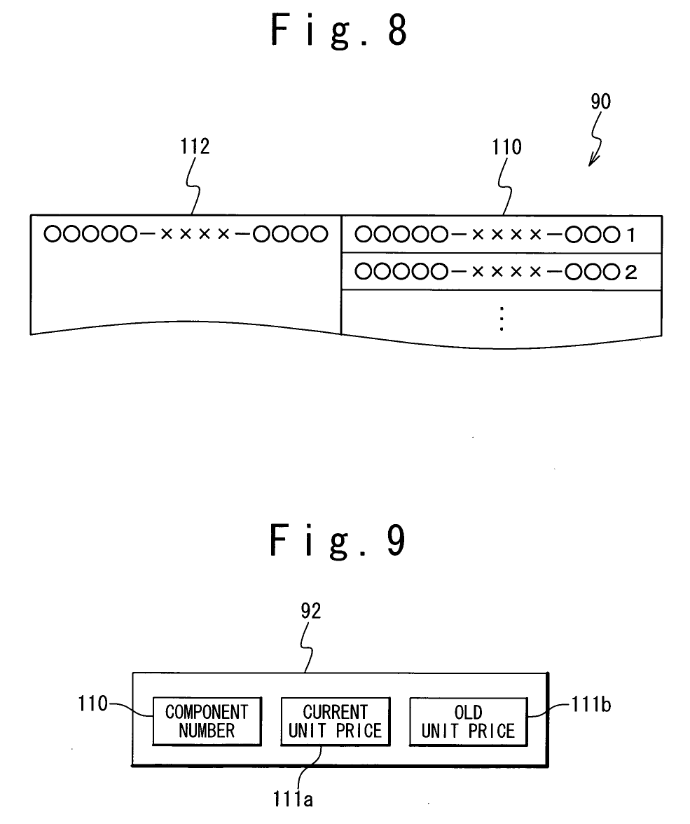

Referring to FIG. 8, the component number database 90 stores SP (spare parts) component numbers 112 and component numbers (or, design-changed component numbers) 110 in correlation with one another. In the event that a design change is made to a repair component corresponding to a component number 110, the component number 110 includes information of a version of the repair component required by design change, thereby to specify that repair component. The SP component number 112 is a number to manage the component in the organization unit being engaged in component design changes. The SP component number 112 does not include the information of the version associated with the design change.

Referring to FIG. 9, the component unit-price database 92 stores component numbers 110, current unit prices 111a, and old unit prices 111b in correlation with one another. Cases can occur wherein current-type components are different in unit price from corresponding old-type components. For example, a redemption expense of a die being used to manufacture motor vehicle components is divided by the number of units scheduled for manufacture, so that the cost of the die is not added to a unit price of an old-type component after the discontinuation of mass production. Since cases can occur wherein such unit price differences need to be calculated, the current unit prices 111a and the old unit prices 111b are stored in the component unit-price database 92. In the event such classifications are not necessary, the current unit price 111a and the old unit price 111b are the same, or only one of the unit prices 111a and 111b is input.

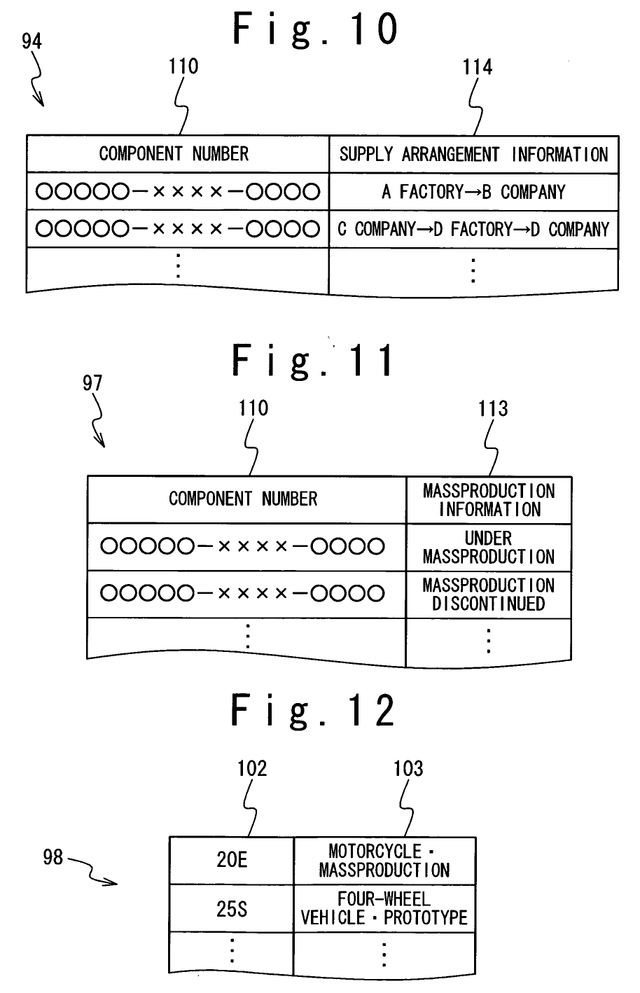

Referring to FIG. 10, the component supply arrangement database 94 stores component numbers 110 and supply arrangement information 114 in correlation with one another. The supply arrangement information 114 includes information of a supply source from which a component is obtained, and supply arrangement procedures.

Referring to FIG. 11, the mass production information database 97 stores component numbers 110 and mass production information 113 in correlation with one another. The mass production information 113 is indicative of whether a component is an under-mass production state or mass production-discontinued state.

Referring to FIG. 12, the category database 98 stores product IDs 102 and category information 103. The category information 103 represents categories of products. For example, the information represents categories of mass produced products and prototype products, and vehicle categories of motorcycles and four-wheel vehicles.

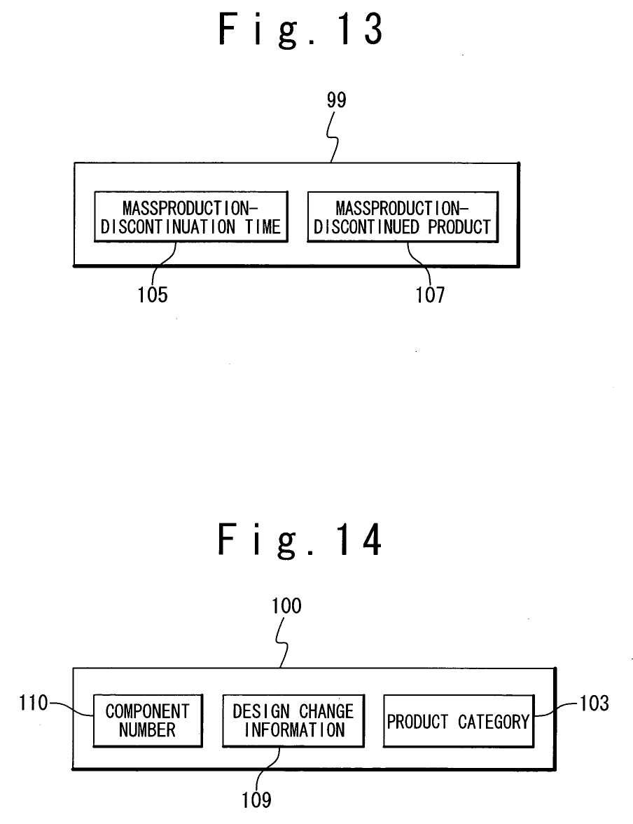

Referring to FIG. 13, the mass production-discontinued product information database 99 stores mass production-discontinuation time 105 and mass production-discontinued products 107 in correlation with one another. Ordinarily, the mass production-discontinued product 107 is indicated by a product ID. More specifically, the mass production-discontinued product 107 is an identifier (ID) specifying a mass production-discontinued product. The mass production-discontinuation time 105 is information representing time when the mass production of the corresponding mass production-discontinued product 107 is discontinued.

Referring to FIG. 14, the design change database 100 stores component numbers 110, design change information 109, and product categories in correlation with one another. The design change information 109 is information of a design change being made to a component specified by the component number 110. The product category is an objective product category (category of motorcycles, four-wheel vehicles, or general-purpose machines, for example) of the product to which the design change is made.

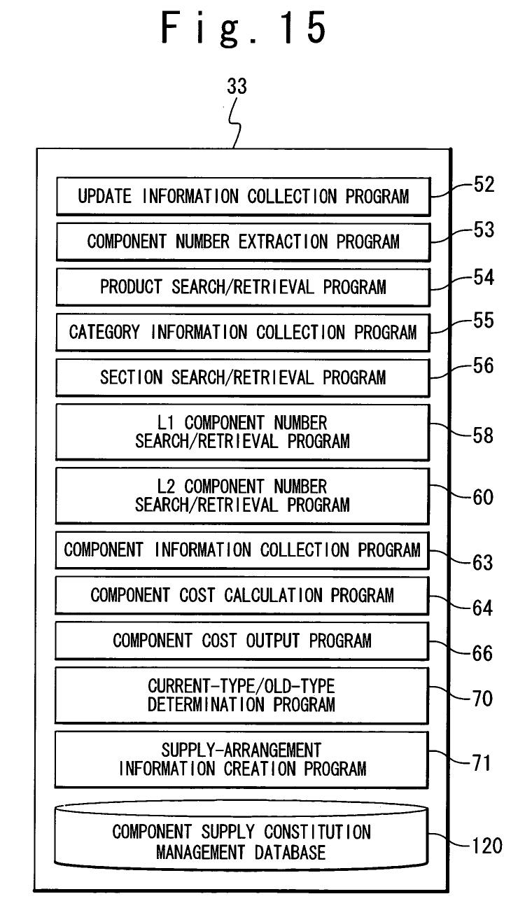

Referring now to FIG. 15, the storage unit 33 of the components-structure-information creation server 30 stores an update information collection program 52, a component number extraction program 53, a product search/retrieval program 54, a category information collection program 55, a section search/retrieval program 56, an L1 component number search/retrieval program 58, an L2 component number search/retrieval program 60, a component information collection program 63, a component cost calculation program 64, a component cost output program 66, a current-type/old-type determination program 70, a supply-arrangement information creation program 71, and a component supply constitution management database 120.

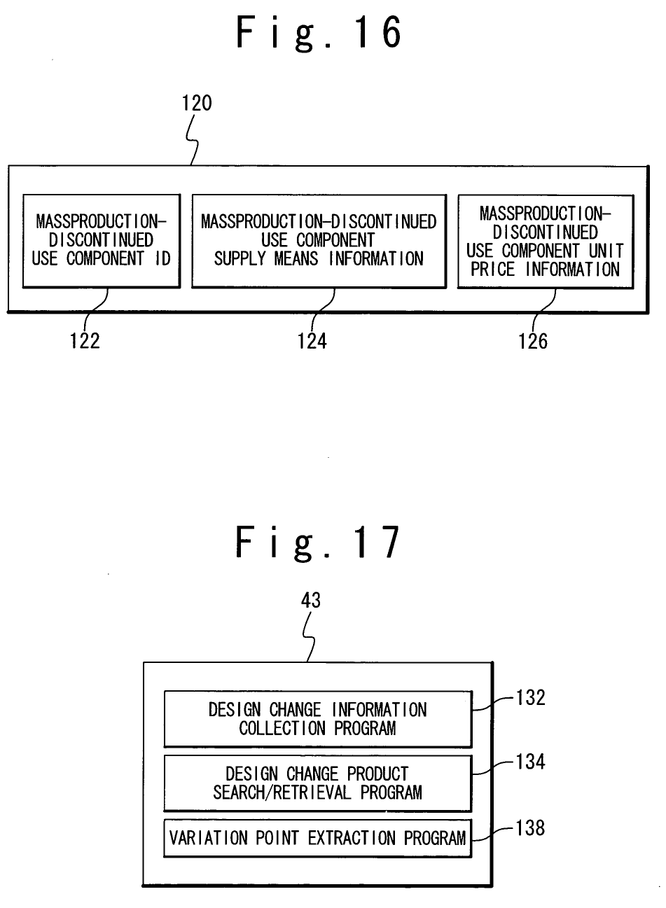

Referring to FIG. 16, the component supply constitution management database 120 stores mass production-discontinued use component IDs 122, mass production-discontinued use component supply means information 124, and mass production-discontinued use component unit price information 126 in correlation with one another. The mass production-discontinued use component ID 122 specifies the type of a component of which mass production is discontinued, and ordinarily, the component number 110 is used therefor. The mass production-discontinued use component supply means information 124 represents a procedure/method for supplying a corresponding to component after the mass production thereof has been discontinued. The mass production-discontinued use component unit price information 126 represents a unit price of a repair component corresponding to a mass production-discontinued product. For motor vehicles, the unit price information 126 represents a “die-less unit price” after deduction of a die cost.

Referring to FIG. 17, there are shown programs stored in the storage unit 43 of the design change information creation server 40. The storage unit 43 stores a design change information collection program 132, a design change product search/retrieval program 134, and a variation point extraction program 138.

Operation of the components-structure management system having the above-described configuration will now be described hereinbelow. Description is given below such that the processing unit 32 of the components-structure-information creation server 30 reads out programs from the storage unit 33, and operation is executed by the read-out programs in accordance with procedures described in the programs. Further, the description is made such that programs are read out by the processing unit 42 of the design change information creation server 40 from the storage unit 43, and operation is executed by the read-out programs in accordance with procedures described in the programs.

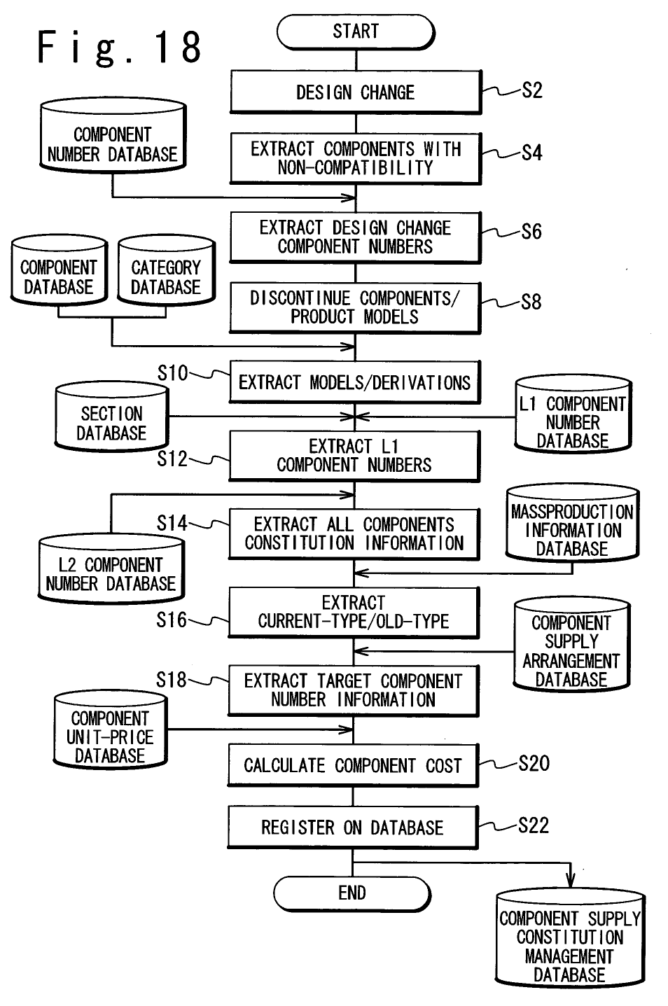

(S2 (“S” stands for “step”)): With reference to FIG. 18, when a design change is made to a component, design change information is entered (or, input) from the input section 14 of the component update information management server 10. The input data is stored into the storage unit 13. The design change information includes an SP component number 112.

(S4): Additionally included in the design change information is compatibility information indicative of compatibility between components prior to the design change (pre-design-change components) and the product after the design change (post-design-change product). The component update information management server 10 performs a determination in accordance with the design change information indicating non-compatibility described in the compatibility information, and transmits the result to the components-structure-information creation server 30.

In the event that compatibility is present between the pre-design-change component and the post-design-change component, the constitution information of the component need not be updated. It is sufficient that, for example, in an event where an order for the component is issued to a manufacturer, a component of a latest version being applied to the product is be selected in accordance with a component number (including no versions occurring due to design changes), which is used as a basic reference.

(S6): The component number extraction program 53 searches the component number database 90 in accordance with an SP component number 112 contained in the received design change information, and then extracts a corresponding (design change) component number 110.

(S8): In the event that the production of a certain product model is discontinued, the update information collection program 52 collects relative information. Typically, the collection is performed in the case that when a vehicle type of a new model is put into the market, mass production of the corresponding old-model vehicle type is discontinued.

Alternatively, when mass production of a certain component is discontinued, the update information collection program 52 together with the component number 110 are input to components-structure-information creation server 30.

(S10): Through the input section 34, an operator enters category information indicative of the product category. The category information represents, for example, categories of motorcycles, four-wheel vehicles, and general-purpose machines; categories of prototype types and mass production types; and categories of engines and frames. Using the component number 110 extracted at S6 as a retrieval key, the product search/retrieval program 54 searches the component database 88 and extracts at least one product ID 102.

The product ID 102 indicates all products to which the component specified by the component number 110 is applied. In the category database 98, among the product IDs 102 is further extracted a product ID 102 corresponding to the product ID 102 having been entered by the operator.

With the category information being used, in the event that, for example, design-change versions different depending on the product category are used, appropriate components structures can easily be created.

(S12): With the product ID 102 being used as a retrieval key, the L1 component number search/retrieval program 58 searches the L1 component number database 82, and extracts L1 component numbers 104. The section search/retrieval program 56 searches the section database 86, and further extracts from the extracted component numbers an L1 component number 104 conforming to the component number 110 and a section 108.

(S14): With the component numbers 104 being used as retrieval keys, the L2 component number search/retrieval program 60 searches the L2 component number database 84, and extracts L2 component numbers 106. According to the manner described above, all component numbers of the product, that is, all components constituting the product indicated in the product ID 102 can be obtained together with a component-to-component hierarchical structure.

(S16): The current-type/old-type determination program 70 searches the mass production information database 97 by using the keys of the component numbers 104 extracted at S12 and the L2 component numbers 106 extracted S14. Thereby, mass production information 113 corresponding to the individual L1 and L2 components having been extracted is obtained. If the mass production information 113 indicates that the component is in an “under-mass production state,” the component is referred to as a “current type.” If the mass production information 113 indicates that the component is in a “mass production-terminated state,” the component is referred to as an “old type.” When production discontinuation information indicating that the production has been discontinued is entered to the components-structure-information creation server 30, the current-type/old-type determination program 70 performs matching comparisons between the production discontinuation information and the component numbers 110. If a match is found, the operation determines that a component number corresponding to the current type has changed to the old type. Concurrently, in the mass production information database 97, the mass production information 113 corresponding to the component number 110 is updated to the “mass production-terminated (discontinued) state.”

For such a component changed to the old type, management should be carried out. For example, management should be carried out for information, such as a procedure, necessary to issue an order to a factory other than an own factory. Alternatively, management should be carried out for information, such as a material and a procedure, necessary for manufacture in an own factory.

As a specific example, suppose that a component is used with a vehicle type; and whereas the manufacture of the vehicle type is discontinued, the component is kept used with a different vehicle type. In this case, the component is referred to as a “current type.” Such components are easily available as repair components since the mass production thereof is continued. For this reason, at and after S18, the processing is performed only for old-type components.

(S18): The supply-arrangement information creation program 71 performs operation to extract supply arrangement information 114 corresponding to all component numbers obtained at S14 from the component supply arrangement database 94. Then, the operation stores into the component supply constitution management database 120 the component numbers as mass production-discontinued use component IDs 122, and concurrently, stores them as mass production-discontinued use component supply means information 124 in correlation therewith. The component information collection program 63 retrieves information relevant to all the component numbers obtained at S14, and adds the relevant information to mass production-discontinued use component supply means information 124.

If a certain component is of the current type, even after the discontinuation of mass production, the component is kept manufactured in the factory or is kept manufactured in a manufacturer in accordance with orders issued from the factory. As such, a conventional obtainment procedure may be applied to obtain the component as a repair component. Information indicative of the conventional obtainment procedure for the component is recoded into the supply arrangement information 114. If a certain component is of the old type, the component is not any more manufactured in, for example, the own factory. As such, for example, information such as specifying a material of the component, a manufacturing procedure, and/or information regarding a manufacturer to which an order for the component is placed are recorded as supply arrangement information 114.

(S20): The component cost calculation program 64 accesses and references the component unit-price database 92, thereby to perform calculations of costs for all the component numbers. The cost calculations are performed corresponding to the current-type/old-type classifications extracted at S16 by using the current unit prices 111a/old unit prices 111b. The calculated costs are stored as mass production-discontinued use component unit price information 126 into the component supply constitution management database 120. According to the procedure, costs reflecting die costs having been added to the current types and having not been added to the old types can be automatically obtained.

(S22) The mass production-discontinued use component IDs 122, mass production-discontinued use component supply means information 124, and mass production-discontinued use component unit price information 126 registered (stored) into the component supply constitution management database 120 are output to the output section 35. The output processing is performed through the input section 34 of the components-structure-information creation server 30.

According to the operation described above, in the event that a design change is made to a component or in the event that the production of a product or component has been discontinued, updated information of a components structure related to the component is created. Thereby, even after the mass production of a certain vehicle type has been discontinued, the procedure for supply-arranging repair components of which mass production has already been discontinued is smoothly proceeded.

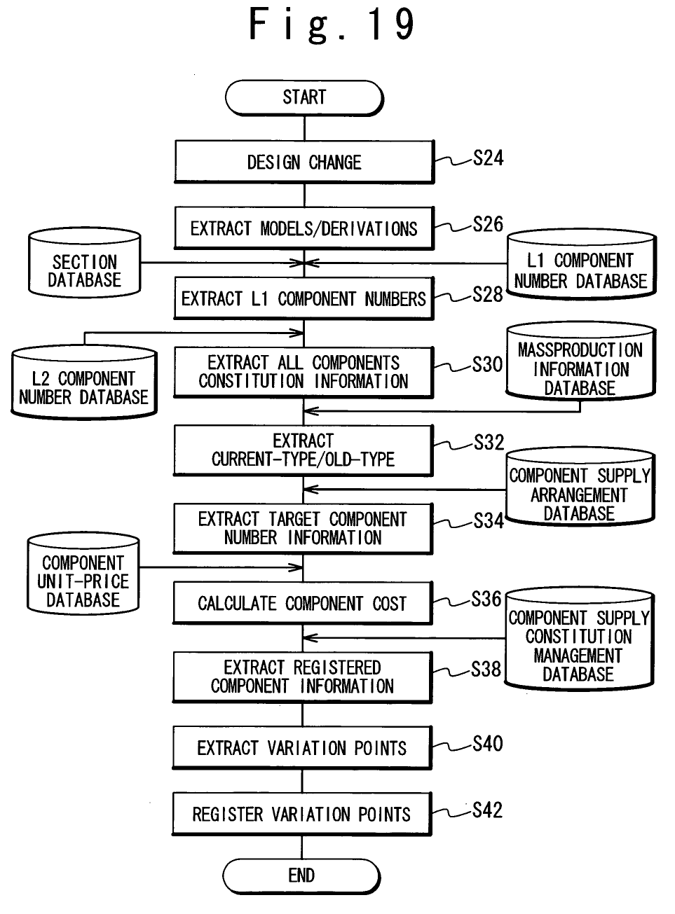

Subsequently, with reference to FIG. 19, the following will describe operation of variation point extraction for extracting information indicating how component structure information has varied. When the operation described below is performed once a day, a list informing of per-day component structure variations on the day can be obtained every day.

(S24): When design change information 109 is registered into the design change database 100, the design change information collection program 132 performs operation to collect information from the design change database 100. The informations are (design change) component numbers 110, design change information 109, and product category 103 to which the design change is applied. Then, the operation stores the collected information into the storage unit 43.

(S26) : An operator enters category the category information 103 of the product category indicative of the product category from the input section. The category information of the product category 103 represents, for example, categories of motorcycles, four-wheel vehicles, and general-purpose machines; categories of prototype types and mass production types; and categories of engines and frames. Using the component number 110 and the product category 103, the design change product search/retrieval program 134 searches the component database 88 and extracts a product ID(s) 102.

(S28) : With the product ID 102 being used as a retrieval key, the L1 component number search/retrieval program 58 searches the L1 component number database 82, and extracts L1 component numbers 104. The section search/retrieval program 56 searches the section database 86, and further extracts from the extracted component numbers an L1 component number 104 conforming to the component number 110 and a section 108.

(S30): With the component numbers 104 being used as retrieval keys, the L2 component number search/retrieval program 60 searches the L2 component number database 84, and extracts L2 component numbers 106. According to the manner described above, all component numbers of the product, that is, all components constituting the product indicated in the product ID 102 can be obtained together with a component-to-component hierarchical structure.

(S32): The current-type/old-type determination program 70 determines whether the component indicated in the respective component number 110 is of the current type or old type. When production discontinuation information indicating that the production has been discontinued is entered to the components-structure-information creation server 30, the current-type/old-type determination program 70 performs matching comparisons between the production discontinuation information and the component numbers 110. If a match is found, the operation determines that a component number corresponding to the current type has changed to the old type.

A component of the current type is easily available as a repair component since the mass production thereof is continued. For this reason, at and after S18, the processing is performed only for old-type components.

(S34): The component information collection program 63 retrieves information relevant to all the component numbers obtained at S14, and adds the relevant information. The relevant information is indicative of, for example, the component name and a procedural sequence for making arrangements for the component with which one of manufacturers.

(S36): The component cost calculation program 64 accesses and references the component unit-price database 92, thereby to perform calculations of costs for all the component numbers. The cost calculations are performed corresponding to the current-type/old-type classifications extracted at S16 by using the current unit prices 111a/old unit prices 111b.

(S38): From component structure information already stored in a component structure information database, a variation-point extraction program 138 extracts component structure information corresponding to portions where the components structure has varied in conjunction with the components having undergone the present new design change.

(S40):The variation-point extraction program 138 performs a comparison between the component structure information extracted at S38 and the component structure varied in conjunction with the components having undergone the present new design change, and extracts differential portions as variation points. The variation-point extraction program 138 stores a list of the extracted variation points into the storage unit 33, and outputs to the output section 35(monitor and/or printer, for example).

The variation point extraction enables quickly knowing that constitution information for supplying a repair component after the mass production discontinuation has design change information on components related to the repair components. As such, a repair component in accordance with a latest-possible design change is provided to a user. Further, depending on the needs of a user, the repair component of a version prior to the design change can be supplied.

(S42): The variation-point extraction program 138 writes all-component information varied in conjunction with the preset design change to the component structure information database.

According to the components-structure management system described above, portions where the component structure has varied can easily be acquired. Further, component design changes are appropriately and progressively reflected in the repair-component supply method configuration.

It will be obvious to one skilled in the art that the present invention may be practiced in other embodiments that depart from the above-described specific details. The scope of the present invention, therefore, should be determined by the following claims.

1. A components-structure management system comprising:
a component management server; and
a components-structure-information creation server connected to said component management server through a communication network,
wherein said component management server includes:
a component management database configured to associate product IDs specifying kinds of products which are mass-produced and component IDs specifying kinds of components used for said products, said component management database storing said component IDs of components having a hierarchical relationship from a larger component to a smaller component together with said hierarchical relationship;
a mass production-discontinued product information database configured to store discontinued product IDs which are said product IDs specifying mass production mass production-discontinued products;
a mass production component information database configured to store discontinued component IDs which are said component IDs specifying mass production-discontinued components;
a component supply arrangement database configured to store said component IDs and supply arrangement information describing procedures of arranging said components specified by said components IDs in correlation with one another; and
a unit price database configured to store said component IDs and unit price information indicating unit prices of said components after mass production of said components specified by said component IDs is discontinued in correlation with one another,
said components-structure-information creation server includes:
a mass production-discontinued product information collection unit configured to collect said discontinued product IDs stored in said mass production-discontinued product information database from said component management server;
a use-component extraction unit configured to extract as use-component IDs said component IDs of said components in all hierarchies associated with said discontinued product IDs in said component management database, when said mass production-discontinued product information collection unit collects said discontinued product IDs;
a discontinued use-component extraction unit configured to extract as discontinued use-component IDs said use-component IDs which are in accordance with said discontinued component IDs in said mass production-discontinued component information database, when said use-component extraction unit extracts said use-components IDs;
a supply arrangement information extraction unit configured to extract supply arrangement information associated with said discontinued use-component IDs in said component supply arrangement database as mass production-discontinued use-component supply means information, when said discontinued use-component extraction unit extracts said discontinued use-component IDs;
a unit price information extraction unit configured to extract unit price information associated with said discontinued use-component IDs in said unit price database as mass production-discontinued use-component unit price information, when said discontinued use-component extraction unit extracts said discontinued use-component IDs;
a component supply constitution management database configured to store said discontinued use-component IDs, said mass production-discontinued use-component supply means information, and said mass production-discontinued use-component unit price information in correlation with one another; and
an input-output apparatus configured to search said component supply constitution management database.

2. The components-structure management system according to claim 1,
wherein said component management server further includes a section database configured to store section IDs specifying sections which are parts constituting a product and said component IDs specifying components which are used in said sections specified by said section IDs and are located at a top-level hierarchy in said component management database, and
said use-component extraction unit extracts all of said use-component IDs in accordance with classifications of said sections by using said component management database.

3. The components-structure management system according to claim 1, further comprising a design change information creation server,
wherein said component management server further includes a design change database configured to store said component IDs and design change information indicating design changes performed for components specified by said component IDs in correlation with one another,
said design change information creation server includes:
a design change information collection unit configured to collect said component IDs and said design change information from said design change database;
a design change product search/retrieval unit configured to search said component management database for a design change ID specifying a design change product which is a product to which design change components which are said components collected by said design change information collection unit are applied; and
a variation components list generating unit configured to extract as design-changed-product-using components said components in all hierarchies of said hierarchical relationship associated with said design change product in said component management database, and to generate and output a variation components list which indicates difference between said extracted design-changed-product-using components and use components stored in said component supply constitution management database.

4. The components-structure management system according to claim 2, further comprising a design change information creation server,
wherein said component management server further includes a design change database configured to store said component IDs and design change information indicating design changes performed for components specified by said component IDs in correlation with one another,
said design change information creation server includes:
a design change information collection unit configured to collect said component IDs and said design change information from said design change database;
a design change product search/retrieval unit configured to search said component management database for a design change ID specifying a design change product which is a product to which design change components which are said components collected by said design change information collection unit are applied; and
a variation components list generating unit configured to extract as design-changed-product-using components said components in all hierarchies of said hierarchical relationship associated with said design change product in said component management database, and to generate and output a variation components list which indicates difference between said extracted design-changed-product-using components and use components stored in said component supply constitution management database.

5. The components-structure management system according to claim 3,
wherein said component management server further includes a category database configured to store said product IDs and category information indicating product categories to which said products belong in correlation with one another,
said design change database stores said component IDs and said product categories in which said design changes are performed for components specified by said component IDs in correlation with one another, and
said variation components list generating unit outputs said variation components list in accordance with classifications of said product categories.

6. The components-structure management system according to claim 4,
wherein said component management server further includes a category database configured to store said product IDs and category information indicating product categories to which said products belong in correlation with one another,
said design change database stores said component IDs and said product categories in which said design changes are performed for components specified by said component IDs in correlation with one another, and
said variation components list generating unit outputs said variation components list in accordance with classifications of said product categories.

7. The components-structure management system according to claim 1,
wherein said components are used for repairing a vehicle.

8. The components-structure management system according to claim 2,
wherein said components are used for repairing a vehicle.

9. The components-structure management system according to claim 3,
wherein said components are used for repairing a vehicle.

10. The components-structure management system according to claim 4,
wherein said components are used for repairing a vehicle.

11. The components-structure management system according to claim 5,
wherein said components are used for repairing a vehicle.

12. The components-structure management system according to claim 6,
wherein said components are used for repairing a vehicle.
